(19) United States
(12) Patent Application Publication
(10) Pub. No.: US 2019/0204656 A1
(43) Pub. Date: Jul. 4, 2019

(54) CUSHIONING BOARD AND PACKAGING STRUCTURE OF LIQUID CRYSTAL PANEL

(71) Applicant: HUIZHOU CHINA STAR OPTOELECTRONICS TECHNOLOGY CO., LTD., Huizhou Guangdong (CN)

(72) Inventor: Chengling LV, Huizhou Guangdong (CN)

(21) Appl. No.: 15/951,090

(22) Filed: Apr. 11, 2018

Related U.S. Application Data
(63) Continuation of application No. PCT/CN2018/074207, filed on Jan. 25, 2018.

(30) Foreign Application Priority Data
Dec. 28, 2017 (CN) 201711467199.9

(51) Int. Cl. G02F 1/1333

(52) U.S. Cl. CPC G02F 1/133305; G02F 2001/133328; G02F 2001/133322

(57) ABSTRACT

A cushioning board is provided, including a board body, a first limiting structure disposed on a first surface of the board body, and a second limiting structure disposed on a second surface of the board body opposite to the first surface. A packaging structure of a liquid crystal panel is further provided, including a side cushioning board and two cushioning boards, the two cushioning boards are oppositely disposed and the two first or second limiting structures are opposite to each other. The side cushioning board is arranged between the two cushioning boards, and the side cushioning board includes a third limiting structure. The cushioning board and the packaging structure of the liquid crystal panel according to the disclosure improve the utilization rate of the cushioning board, and the packaging of different types of liquid crystal panels is realized, the storage pressure is relieved, and the packaging cost is reduced.

### RELATED APPLICATIONS

The present application is a Continuation Application of International Application Number PCT/CN2018/074207, filed Jan. 25, 2018, and claims the priority of China Application No. 201711467199.9, filed Dec. 28, 2017, which is herein incorporated by reference in its entirety.

### FIELD OF THE DISCLOSURE

The disclosure relates to the field of liquid crystal panel packaging, and more particularly to a cushioning board and a packaging structure of a liquid crystal panel.

### BACKGROUND

The current liquid crystal display televisions are getting higher and higher share of the market, many manufacturers ship both planar and curved liquid crystal modules. The most commonly used material for the internal cushioning device of the liquid crystal display module package is expandable polyethylene (EPE), which is more expensive and less recyclable since the shipping packaging of planar and curved modules are not shared, especially when the size of the liquid crystal module trends is growing, different types of cushioning material inventory takes up space, greatly increasing storage and transportation costs.

### SUMMARY

A technical problem to be solved by the disclosure is to overcome the shortcomings of the prior art and to provide a cushioning board and a packaging structure of a liquid crystal panel capable of packaging not only a planar liquid crystal panel but also a curved liquid crystal panel.

To achieve the object, the disclosure adopts the following technical proposal:

a cushioning board, including a board body, a first limiting structure disposed on a first surface of the board body, and a second limiting structure disposed on a second surface of the board body opposite to the first surface, and the first limiting structure is configured to fix a planar liquid crystal panel, and the second limiting structure is configured to fix a curved liquid crystal panel.

Optionally, the first limiting structure includes a plurality of first limiting units spaced on the first surface, a plurality of first limiting slots are disposed at intervals on each of the first limiting units, and the first limiting slots are separately configured to fix the planar liquid crystal panel.

Optionally, the second limiting structure includes a plurality of second limiting units disposed at intervals on the second surface, each of the second limiting units includes a plurality of second limiting slots, and the second limiting slots are separately configured to fix the curved liquid crystal panel.

Optionally, the first limiting structure and/or the second limiting structure are integrally formed with the board body.

The disclosure also discloses a packaging structure of a liquid crystal panel, including a side cushioning board and two of any one of the cushioning boards, the two of the cushioning boards are oppositely disposed, and two of the first limiting structures or two of the second limiting structures are opposite to each other; the side cushioning board is disposed between the two of the cushioning boards, and the side cushioning board includes a third limiting structure configured to fix the planar liquid crystal panel or the curved liquid crystal panel.

Optionally, the third limiting structure is a plurality of third limiting slots disposed at intervals on a surface of the side cushioning board.

Optionally, two opposite inner walls of each of the third limiting slots both include an elastic structure, configured to elastically contact and fix the planar liquid crystal panel or the curved liquid crystal panel.

Optionally, the elastic structure includes a plurality of convex hulls disposed at intervals.

Optionally, the elastic structure is serrated.

Optionally, a number of the cushioning board is two, and two of the side cushioning boards are disposed opposite to each other, and two of the third limiting structures are opposite to each other.

The disclosure discloses a cushioning board and a packaging structure of a liquid crystal panel. By providing two different types of limiting structures on the two surfaces of the cushioning board, the fixing of different types of liquid crystal panels can be realized, the utilization rate of the cushioning board is improved; simultaneously, through the cooperation of the cushioning boards and the side cushioning board, the packaging of different types of liquid crystal panels is realized, the storage pressure is relieved, and the packaging cost is reduced.

### BRIEF DESCRIPTION OF THE DRAWINGS

FIG. 1 is a schematic view of a cushioning board according to a first embodiment of the disclosure.

FIG. 2 is another schematic view of a cushioning board according to the first embodiment of the disclosure.

FIG. 3 is a schematic diagram of a package structure of a liquid crystal panel according to a second embodiment of the disclosure.

FIG. 4 is a cross-sectional view of a side cushioning board according to a second embodiment of the disclosure.

FIG. 5 is another cross-sectional view of a side cushioning board according to the second embodiment of the disclosure.

### DETAILED DESCRIPTION OF PREFERRED EMBODIMENTS

In order to make the objectives, technical solutions and advantages of the disclosure more comprehensible, the disclosure is further described in detail below with reference to the accompanying drawings and embodiments. It is to be understood that the specific embodiments described herein are merely illustrative of the disclosure and are not intended to be limiting of the disclosure.

### Embodiment 1

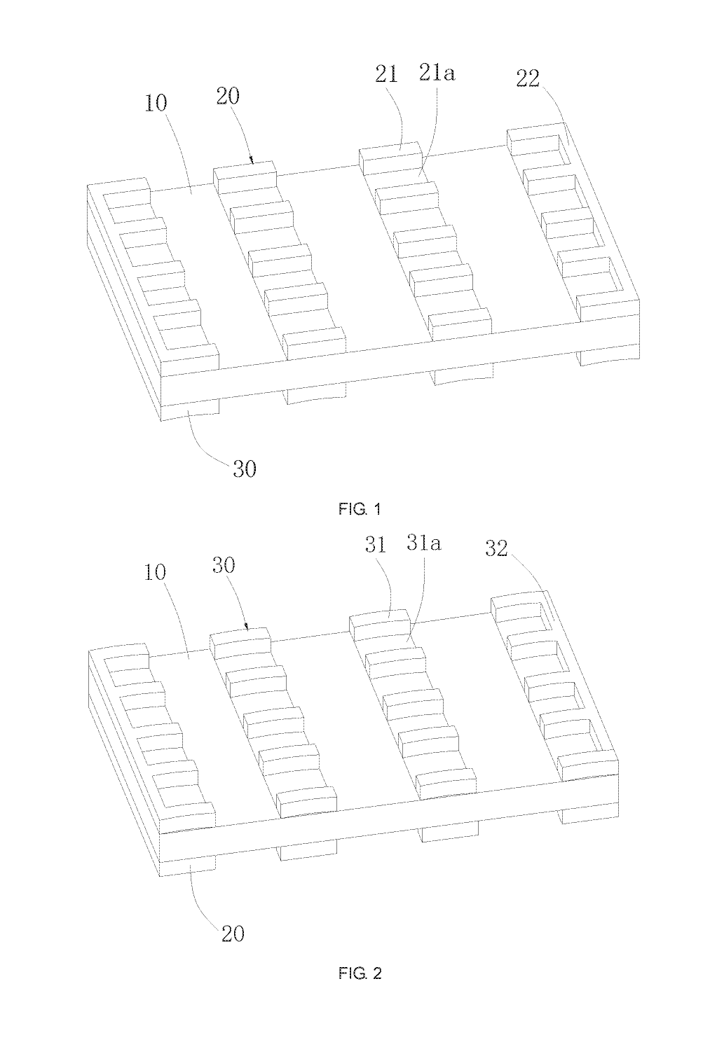

As shown in FIG. 1 and FIG. 2, the cushioning board of the embodiment includes a board body 10, a first limiting structure 20 disposed on a first surface of the board body 10, and a second limiting structure 30 disposed on a second surface of the board body 10 opposite to the first surface. The first limiting structure 20 is configured to fix a planar liquid crystal panel, and the second limiting structure 30 is configured to fix a curved liquid crystal panel, so that the same cushioning board can fix different types of liquid crystal panels, thereby improving the utilization rate of the cushioning board.

Specifically, as shown in FIG. 1, the first limiting structure 20 includes a plurality of first limiting units 21 disposed on the first surface, the first limiting units 21 are disposed at equal intervals, and each of the first limiting units 21 includes a plurality of first limiting slots 21a, and the first limiting slots 21a are disposed at equal intervals. A distance between two opposite inner walls of each of the first limiting slots 21a is adapted to a thickness of a planar liquid crystal panel. An end of the liquid crystal panel is inserted into the first limiting slots 21a to limit the position of the planar liquid crystal panel. To prevent the planar liquid crystal panel from slipping off from the first limiting slots 21a located on both sides of the board body 10, the first limiting slots 21a of the two of the first limiting units 21 on the outer side are disposed with a first blocking portion 22, and the first blocking portion 22 is connected to an end of the first limiting slots 21a away from the board body 10.

Specifically, as shown in FIG. 2, the second limiting structure 30 includes a plurality of second limiting units 31 disposed on the second surface, and the second limiting units 31 are disposed at equal intervals. Each of the second limiting units includes a plurality of second limiting slots 31a, and the second limiting units 31a are disposed at equal intervals, and a shape and a thickness of the second limiting slots 31a are matched with the curved liquid crystal panel. An end of the curved liquid crystal panel is inserted into the second limiting slots 31a to limit the position of the curved liquid crystal panel. To prevent the curved liquid crystal panel from slipping off from the second limiting slots 31a located on both sides of the board body 10, the second limiting slots 31a of the two second limiting units 31 on the outer side are disposed with a second blocking portion 32, and the second blocking portion 32 is connected to an end of the second limiting slot 31a away from the board body 10.

Of course, in other embodiments, both the first limiting structure 20 and the second limiting structure 30 are integrally formed with the board body 10. The board body 10 having a thicker thickness may be provided for cutting on the first surface and the second surface of the board body 10 respectively, so as to form the first limiting structure 20 as shown in FIG. 1 and the second limiting structure 30 as shown in FIG. 2.

### Embodiment 2

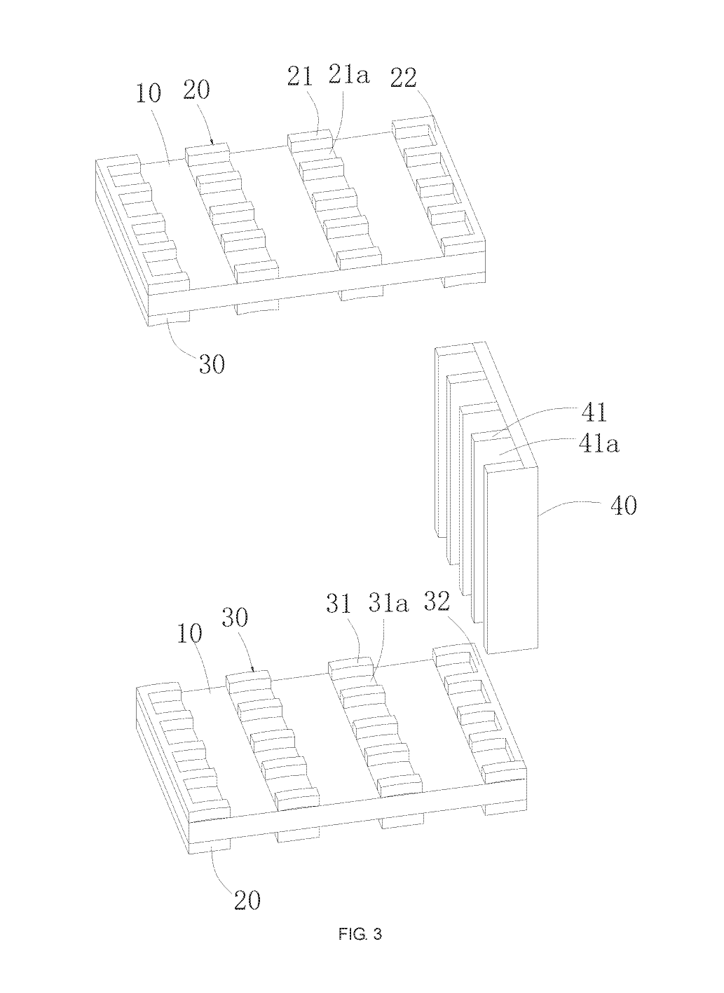

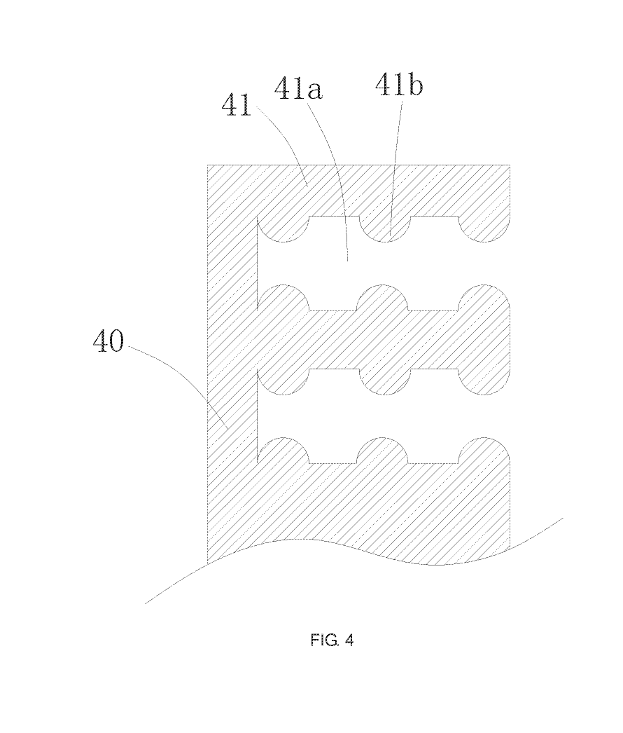

As shown in FIG. 3, the packaging structure of a liquid crystal panel in this embodiment includes a side cushioning board 40 and two of the cushioning boards in the first embodiment. The two of the cushioning boards are disposed opposite to each other, and two of the first limiting structures 20 or two of the second limiting structures 30 are opposite to each other. The side cushioning board 40 is disposed between the two of the cushioning boards. The side cushioning board 40 includes a third limiting structure 41 configured to fix a planar or curved liquid crystal panel. In specific use, one of the cushioning boards is configured as a base board, an end of the liquid crystal panel is first inserted into the corresponding limiting structure on the base board, and then the side cushioning board 40 is placed from the side of the base board so that the third limiting structure 41 fixes the liquid crystal panel; finally, a limiting structure corresponding to the other cushioning board is sleeved on the other of the liquid crystal panel to realize the packaging of the liquid crystal panel.

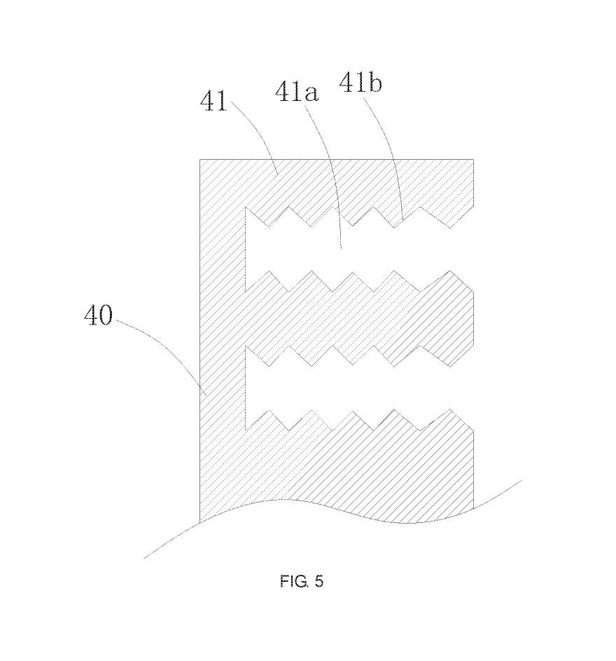

Specifically, as shown in FIG. 4, the third limiting structures 41 include a plurality of third limiting slots 41a disposed on a surface of the side cushioning board 40, the third limiting slots 41a are disposed at equal intervals, and the number of the third limiting slots 41a is the same as the number of the first limiting slots 21a and the number of the second limiting slots 31a, and the shape and size of the third limiting slots 41a is matched with the shape and size of the liquid crystal panel. On one hand, the side cushioning board 40 can prevent a collision between the liquid crystal panels to achieve a buffering function, and on the other hand, it can prevent external dust from entering the gap of the liquid crystal panel.

Further, two opposite inner walls of each of the third limiting slots 41a both include an elastic structure 41b. The elastic structure 41 elastically abuts on the liquid crystal panel to limit and buffer the liquid crystal panel. At the same time, the elastic structure 41b has stronger deformability, which can be applied to fix a planar liquid crystal panel and a curved liquid crystal panel, thereby improving the utilization rate of the side cushioning board 40.

As a preferred embodiment, the elastic structure 41b includes a plurality of convex hulls disposed at intervals. The convex hulls have a hemispherical shape. The convex hulls can be deformed in various directions to accommodate different types of liquid crystal panels. Of course, in other embodiments, as shown in FIG. 5, the elastic structure 41b may also be in a serrated shape, and the interaction between the elastic structure 41b and the liquid crystal panel is larger, so as to achieve a more stable limit.

Further, the number of the side cushioning board 40 is two, two of the side cushioning boards 40 are disposed opposite to each other, and two of the third limiting structures 41 are opposite to each other, so as to further enhance the buffering capacity of the packaging structure.

The disclosure discloses a cushioning board and a packaging structure of a liquid crystal panel. By providing two different types of limiting structures on the two surfaces of the cushioning board, the fixing the different types of liquid crystal panels and improve the utilization of the cushioning board; simultaneously, through the cooperation of the cushioning boards and the side cushioning board, the packaging of different types of liquid crystal panels can be realized, the storage pressure can be relieved, and the packaging cost can be reduced.

While specific embodiments of the invention have been described in detail, while some embodiments have been shown and described, it will be understood by those skilled in the art that various changes and modifications may be made without departing from the spirit and scope of the invention as defined by the appended claims and their equivalents, these embodiments may be modified and improved, and these modifications and improvements should also fall within the protection scope of the disclosure.

What is claimed is:

1. A cushioning board, comprising:
a board body,
a first limiting structure disposed on a first surface of the board body; and
a second limiting structure disposed on a second surface of the board body opposite to the first surface;
wherein the first limiting structure is configured to fix a planar liquid crystal panel, and the second limiting structure is configured to fix a curved liquid crystal panel.

2. The cushioning board according to claim 1, wherein the first limiting structure comprises a plurality of first limiting units disposed at intervals on the first surface, a plurality of first limiting slots are disposed at intervals on each of the first limiting units, and the first limiting slots are respectively configured to fix the planar liquid crystal panel.

3. The cushioning board according to claim 1, wherein the second limiting structure comprises a plurality of second limiting units disposed at intervals on the second surface, and a plurality of second limiting slots are disposed at intervals on each of the second limiting units, and the second limiting slots are respectively configured to fix the curved liquid crystal panel.

4. The cushioning board according to claim 1, wherein the first limiting structure and/or the second limiting structure are integrally formed with the board body.

5. A packaging structure of a liquid crystal panel, comprising:
a side cushioning board; and
two cushioning boards;
wherein each of the two cushioning boards comprises a board body, a first limiting structure disposed on a first surface of the board body, and a second limiting structure disposed on a second surface of the board body opposite to the first surface, the first limiting structure is configured to fix a planar liquid crystal panel, and the second limiting structure is configured to fix a curved liquid crystal panel;
wherein the two cushioning boards are disposed opposite to each other and two of the first limiting structures or two of the second structures are opposite to each other, the side cushioning board is disposed between the two cushioning boards, and the side cushioning board comprises a third limiting structure configured to fix the planar liquid crystal panel or the curved liquid crystal panel.

6. The packaging structure of the liquid crystal panel according to claim 5, wherein the first limiting structure comprises a plurality of first limiting units disposed at intervals on the first surface, a plurality of first limiting slots is disposed at intervals on each of the first limiting units, and the first limiting slots are respectively configured to fix the planar liquid crystal panel.

7. The packaging structure of the liquid crystal panel according to claim 5, wherein the second limiting structure comprises a plurality of second limiting units disposed at intervals on the second surface, a plurality of second limiting slots is disposed at intervals on each of the second limiting units, and the second limiting slots are respectively configured to fix the curved liquid crystal panel.

8. The liquid crystal panel package structure according to claim 5, wherein the first limiting structure and/or the second limiting structure are integrally formed with the board body.

9. The packaging structure of the liquid crystal panel according to claim 5, wherein the third limiting structure comprises a plurality of third limiting slots disposed at intervals on a surface of the side cushioning board.

10. The packaging structure of the liquid crystal panel according to claim 9, wherein two opposite inner walls of each of the third limiting slots both comprise an elastic structure, configured to elastically contact and fix the planar liquid crystal panel or the curved liquid crystal panel.

11. The packaging structure of the liquid crystal panel according to claim 10, wherein the elastic structure comprises a plurality of convex hulls arranged at intervals.

12. The packaging structure of the liquid crystal panel according to claim 10, wherein the elastic structure is serrated.

13. The packaging structure of the liquid crystal panel according to claim 9, wherein a number of the side cushioning board is two, and two of the side cushioning boards are disposed opposite to each other, and two of the third limiting structures are opposite to each other.
